(19) United States
(12) Patent Application Publication
(10) Pub. No.: US 2010/0244772 A1
(43) Pub. Date: Sep. 30, 2010

(54) Battery module

(76) Inventors: Chia-Han Chan, Tu-Cheng City (TW); Nan-Sheng Chang, Tu-Cheng City (TW); Chieh-Hung Yang, Tu-Cheng City (TW); Chuan-Jung Wang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/384,089

(22) Filed: Mar. 30, 2009

(51) Int. Cl. H02J 7/00

(52) U.S. Cl. 320/137

(57) ABSTRACT

A battery module adapted for supplying power to an electric equipment includes an energy battery device, a power battery device and a charging device. The energy battery device includes a plurality of parallel conductive plates and energy battery groups each connected between the neighboring two conductive plates and including a plurality of parallel-connected energy cells. The power battery device is adapted to be connected with the supplied electric equipment and includes a power battery group formed by a series-connection of a plurality of power cells. The charging device has two input terminals connecting the energy battery device therebetween and two output terminals connecting the power battery device therebetween so that the power battery group can be charged by the energy battery device, the two output terminals connected with the electric equipment for supplying power to the electric equipment by the energy cells.

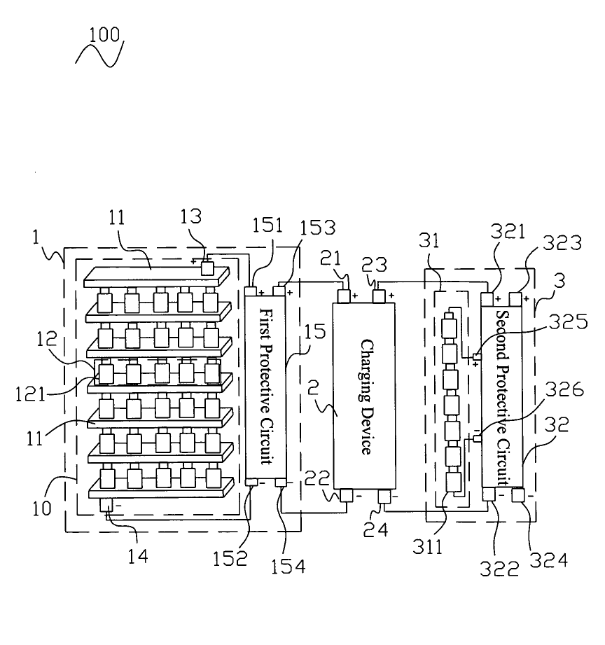

### BACKGROUND OF THE INVENTION

1. Field of the Invention

The present invention generally relates to a battery module, and more particularly to a battery module having an improved structure for supplying power to an exterior electric equipment.

2. The Related Art

With the development of electrical technology, a battery module has been widely used in our daily life as a power source so as to supply power to an exterior electric equipment. The battery module primarily has two kinds, energy battery module and power battery module. The energy battery module generally utilizes a plurality of energy cells to supply power, and the power battery module generally utilizes a plurality of power cells to supply power. The energy cell has a relatively larger capacity, but a high-current environment is apt to result in a higher temperature of the energy cell and speed up the aging of the energy cell. The power cell of the power battery module has a relatively higher output power to meet the high-current environment, however, the power cell has half the capacity of the energy cell but has 2˜3 times the cost of the energy cell. Therefore, a battery module capable of combining the advantages of the energy cell and the power cell is required.

### SUMMARY OF THE INVENTION

An object of the present invention is to provide a battery module adapted for supplying power to an electric equipment. The battery module includes an energy battery device, a power battery device and a charging device. The energy battery device includes a plurality of parallel conductive plates and a plurality of energy battery groups. Each of the energy battery groups is connected between the neighboring two conductive plates and includes a plurality of parallel-connected energy cells. The power battery device is adapted to be connected with the supplied electric equipment and includes a power battery group formed by the series-connection of a plurality of power cells. The charging device has two input terminals connecting the energy battery device therebetween and two output terminals connecting the power battery device therebetween so that the power battery group can be charged by the energy battery device. The two output terminals of the charging device are adapted to be connected with the electric equipment so as to supply power to the electric equipment by the energy cells of the energy battery device.

As described above, the battery module utilizes the energy battery device and the power battery device together to supply power to the electric equipment. Furthermore, the energy cells of the energy battery device can charge the power cells of the power battery group through the charging device. Therefore, the foregoing battery module combines the advantages of the power cell and the energy cell. So the battery module of the present invention has not only a relatively larger capacity but also a relatively lower cost.

### BRIEF DESCRIPTION OF THE DRAWINGS

The present invention will be apparent to those skilled in the art by reading the following description, with reference to the attached drawing, in which:

The FIGURE is a view of a battery module of the present invention.

### DETAILED DESCRIPTION OF THE PREFERRED EMBODIMENT

With reference to the FIGURE, a battery module 100 according to the present invention includes an energy battery device 1, a charging device 2 and a power battery device 3.

The energy battery device 1 includes an energy battery unit 10 and a first protective circuit 15. The energy battery unit 10 includes a plurality of rectangular conductive plates 11 and a plurality of energy battery groups 12. The conductive plates 11 are parallel to each other and every two neighboring conductive plates 11 are spaced from each other. Each of the energy battery groups 12 has a plurality of energy cells 121 parallel-connected between the neighboring two conductive plates 11. A positive connecting portion 13 protrudes upward from one end of the top conductive plate 11, and a negative connecting portion 14 protrudes downward from the other end of the bottom conductive plate 11 so that can ensure a substantially equal current to pass through every energy cell 121 and improve the charging and discharging efficiency of the energy battery unit 10. The first protective circuit 15 has a positive input portion 151 connected with the positive connecting portion 13, a negative input portion 152 connected with the negative connecting portion 14, a positive output portion 153 and a negative output portion 154. The first protective circuit 15 can detect the current, voltage and temperature of the energy cells 121 so as to protect the energy cells 121.

The charging device 2 has a positive input terminal 21, a negative input terminal 22, a positive output terminal 23 and a negative output terminal 24. The positive input terminal 21 is connected with the positive output portion 153, and the negative input terminal 22 is connected with the negative output portion 154. Therefore, the energy battery device 1 can supply power to the charging device 2.

The power battery device 3 includes a power battery group 31 and a second protective circuit 32. The power battery group 31 has a plurality of power cells 311 connected in series. The second protective circuit 32 has a positive input port 321, a negative input port 322, a positive output port 323, a negative output port 324, a positive connecting port 325 and a negative connecting port 326. The positive electrode of the top power cell 311 is connected to the positive connecting port 325 and the negative electrode of the bottom power cell 311 is connected to the negative connecting port 326. As a result, the second protective circuit 32 can detect the current, voltage and temperature of the power cells 311 so as to protect the power cells 311. The positive input port 321 is connected with the positive output terminal 23 of the charging device 2, and the negative input port 322 is connected with the negative output terminal 24 of the charging device 2. Therefore, the charging device 2 can charging the power battery group 31 after being supplied power by the energy battery device 1.

When the foregoing battery module 100 is in use, the positive output port 323 is connected to a positive pole of an exterior electric equipment (not shown), and the negative output port 324 is connected to a negative pole of the electric equipment so as to supply power to the electric equipment by the battery module 100. The electric equipment is supplied power mainly by the power battery device 3 and secondarily by the energy battery device 1, because the current supplied by the power battery device 3 is relatively higher than the current supplied by the energy battery device 1 through the charging device 2. When the power cells 311 of the power battery group 31 are discharged to be over, the charging device 2 can charge the power cells 311 by means of the energy battery device 1 during supplying power to the electric equipment. The power battery device 3 re-supplies power to the electric equipment after being completely charged.

As described above, the battery module 100 of the present invention utilizes the energy battery device 1 and the power battery device 3 together to supply power to the electric equipment, wherein the power battery device 3 supplies power to the electric equipment as a main power source, the energy battery device 1 not only can supply power to the electric equipment as a secondary power source, but also can charge the power cells 311 of the power battery group 31. Therefore, the battery module 100 combines the advantages of the power cell 311 and the energy cell 121. So the battery module 100 of the present invention has not only a relatively larger capacity but also a relatively lower cost.

What is claimed is:

1. A battery module adapted for supplying power to an electric equipment, comprising:
an energy battery device including a plurality of parallel conductive plates and a plurality of energy battery groups, each of the energy battery groups being connected between the neighboring two conductive plates and including a plurality of parallel-connected energy cells;
a power battery device adapted to be connected with the supplied electric equipment and including a power battery group formed by the series-connection of a plurality of power cells; and
a charging device having two input terminals connecting the energy battery device therebetween and two output terminals connecting the power battery device therebetween so that the power battery group being charged by the energy battery device, the two output terminals adapted to be connected with the electric equipment so as to supply power to the electric equipment by the energy cells of the energy battery device.

2. The battery module as claimed in claim 1, wherein every two neighboring conductive plates are disposed face-to-face, a positive connecting portion protrudes from one end of one outermost conductive plate and a negative connecting portion protrudes from the other end of the other outermost conductive plate for respectively connecting the two input terminals of the charging device.

3. The battery module as claimed in claim 2, wherein the energy battery device further includes a first protective circuit having a positive input portion connected with the positive connecting portion, and a negative input portion connected with the negative connecting portion so as to protect the energy cells, the first protective circuit further has a positive output portion and a negative output portion, the two input terminals of the charging device are respectively a positive input terminal and a negative input terminal, the positive output portion is connected with the positive input terminal and the negative output portion is connected with the negative input terminal.

4. The battery module as claimed in claim 1, wherein the two output terminals of the charging device are respectively a positive output terminal and a negative output terminal, the power battery device further includes a second protective circuit having a positive input port connected with the positive output terminal, a negative input port connected with the negative output terminal, two output ports connected with the electric equipment, a positive connecting port and a negative connecting port, the power battery group is connected between the positive connecting port and the negative connecting port so as to be protected by the second protective circuit.
